(19) United States
(12) Patent Application Publication
(10) Pub. No.: US 2010/0303176 A1
(43) Pub. Date: Dec. 2, 2010

(54) METHODS AND APPARATUSES FOR MIMO DETECTION

(75) Inventors: Jorma Olavi Lilleberg, Oulu (FI); Yang Sun, Houston, TX (US); Joseph R. Cavallaro, Pearland, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/475,755

(22) Filed: Jun. 1, 2009

(51) Int. Cl. H04L 27/06

(52) U.S. Cl. 375/341

(57) ABSTRACT

Methods and apparatuses are provided for MIMO detection. A method may include considering a symbol vector received over MIMO system. The method may further include generating a list comprising a predefined number of candidate transmit symbol vectors based at least in part upon the received symbol vector using a trellis comprising a plurality of nodes that apply distributed list decoding to generate the list, wherein the list of the predefined number of candidate transmit symbol vectors comprises the predefined number of candidate transmit symbol vectors derived from the set of all possible trellis paths as determined based at least in part upon the respective cumulative trellis path weights. Corresponding apparatuses are also provided.

### TECHNOLOGICAL FIELD

Embodiments of the present invention relate generally to communication technology and, more particularly, relate to methods and apparatuses for multiple-input, multiple-output (MIMO) detection.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer and providing convenience to users.

One such networking technology that is being developed and deployed is MIMO communication. MIMO communication systems provide greater spectral efficiency than systems using a single transmit antenna and a single receive antenna. In this regard, MIMO communication systems provide for spatial multiplexing such that independent data may be sent over each transmit antenna in a MIMO communication system. Several new wireless communication standards, including, for example, Institute of Electrical and Electronics Engineers (IEEE) 802.11n, IEEE 802.16e, Worldwide Interoperability for Microwave Access (WiMax), Third Generation Partnership (3GPP) Long Term Evolution (LTE), LTE-Advanced, and International Mobile Telecommunications (IMT) Advanced, incorporate MIMO communication techniques.

The challenge in implementing MIMO communications systems is the algorithmic complexity of MIMO detection wherein a receiver of data attempts to detect the received data while limiting the number of bit errors in the detected data. In this regard, maximum-likelihood (ML) decoding is a very computational-intensive task for MIMO wireless channel detection. The exhaust full-search with ML criterion algorithm consumes enormous computing power, which makes it impractical to be employed in the multiple antenna systems with higher-order modulation schemes.

Various previous attempts have been made to implement MIMO detection algorithms to reduce the searching complexity of the MIMO detector. However, these previous attempts have been plagued by deficiencies making them less than optimum for use for MIMO detection. These sub-optimal algorithms can be categorized as either depth-first sphere or breadth-first K-best tree-search algorithms. The depth-first sphere algorithm has non-deterministic complexity and variable throughput which makes it sensitive to the channel conditions. Moreover, the depth-first sphere algorithm with a small candidate list size suffers significant performance degradations due to the inaccurate and especially the infinite log likelihood ratios (LLRs). When K is large in a breath-first K-best algorithm, the complexity of the K-best algorithm dramatically increases because a large number of paths have to be extended and sorted. Sorting is often the bottleneck in K-best detectors, which limits the system throughput performance.

### BRIEF SUMMARY OF SOME EXAMPLES OF THE INVENTION

Methods, apparatuses, and computer program products are therefore provided for MIMO detection. In this regard, methods, apparatuses, and computer program products are provided that may provide several advantages to computing devices and network operators. Embodiments of the invention provide methods, apparatuses, and computer products implementing a distributed list, trellis decoding algorithm having a scalable distributed list size (L) offering greater search efficiencies than prior MIMO detection algorithms. In this regard, embodiments of the invention provide for soft detection of the received symbol vector that may then be forwarded to an outer channel decoder. Some embodiments of the invention use multiple MIMO trellises to generate more accurate log-likelihood ratios for the received symbol vector for forwarding to an outer channel decoder.

Accordingly, various embodiments of the invention provide a search-efficient, distributed list (D-LIST), trellis decoding algorithm for high performance soft MIMO detection. Embodiments of the invention transform the traditional MIMO detection problem into a shortest path finding problem in a MIMO trellis diagram. An algorithm implemented by methods, apparatuses, and computer program products according to some embodiments of the invention determines the minimum Euclidean distance by making a locally optimum choice at each step of the trellis. The number of nodes in a trellis according to embodiments of the invention grows linearly instead of exponentially with the number of transmit antennas. A MIMO detector according to embodiments of the invention may not have prior knowledge of what has been sent and thus each possible transmit symbol in the alphabet may be examined in order to generate the log-likelihood ratio (LLR). To make the searching process efficient and fair among different transmit symbols, embodiments of the invention implement a distributed list (D-LIST), trellis decoding algorithm for soft MIMO detection. Each trellis node in embodiments of the invention is physically mapped to one transmit symbol in the constellation alphabet. The D-LIST algorithm according to embodiments of the invention starts at the first level, or stage, and explores all possible out-going paths. However, instead of letting the number of distinct paths grow exponentially, embodiments of the invention prune unlikely paths by only keeping a predefined distributed list size number (L) most likely, or best, candidates, comprising the paths with the least L cumulative weights among the set of QL incoming paths at each node in the trellis, where Q is the constellation alphabet size.

In a first exemplary embodiment, a method is provided, which comprises considering, at a multiple-input, multiple-output detector, a symbol vector received over a multiple-input, multiple-output system. The method of this embodiment further comprises generating a list comprising a predefined number of candidate transmit symbol vectors based at least in part upon the received symbol vector using a trellis comprising a plurality of nodes that apply distributed list decoding to generate the list. The list of the predefined number of candidate transmit symbol vectors of this embodiment comprises the predefined number of candidate transmit symbol vectors derived from the set of all possible trellis paths as determined based at least in part upon the respective cumulative trellis path weights.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction of this embodiment is for considering a symbol vector received over a multiple-input, multiple-output system. The second program instruction of this embodiment is for generating a list comprising a predefined number of candidate transmit symbol vectors based at least in part upon the received symbol vector using a trellis comprising a plurality of nodes that apply distributed list decoding to generate the list. The list of the predefined number of candidate transmit symbol vectors of this embodiment comprises the predefined number of candidate transmit symbol vectors derived from the set of all possible trellis paths as determined based at least in part upon the respective cumulative trellis path weights.

In another exemplary embodiment, an apparatus is provided. The apparatus of this embodiment comprises at least one processor and at least one memory storing computer program code, wherein the at least one memory and stored computer program code are configured to with the processor cause the apparatus to at least perform considering a symbol vector received over a multiple-input, multiple-output system. The at least one memory and stored computer program code are configured to with the processor cause the apparatus of this embodiment to further perform generating a list comprising a predefined number of candidate transmit symbol vectors based at least in part upon the received symbol vector using a trellis comprising a plurality of nodes that apply distributed list decoding to generate the list. The list of the predefined number of candidate transmit symbol vectors of this embodiment comprises the predefined number of candidate transmit symbol vectors derived from the set of all possible trellis paths as determined based at least in part upon the respective cumulative trellis path weights.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for MIMO detection according to an exemplary embodiment of the present invention;

FIG. 2 is a schematic block diagram of a mobile terminal according to an exemplary embodiment of the present invention;

FIG. 3 illustrates an example trellis diagram for MIMO detection according to an exemplary embodiment of the present invention;

FIG. 4 illustrates a flow diagram of a distributed list trellis decoding algorithm according to an exemplary embodiment of the present invention;

FIG. 5 illustrates an example trellis diagram flow for MIMO detection using a windowed distributed list trellis decoding algorithm according to an exemplary embodiment of the present invention;

FIG. 6 illustrates a block diagram of a multi-trellis distributed list decoding algorithm according to an exemplary embodiment of the present invention;

FIG. 7 illustrates a graph showing a bit error rate performance comparison according to an exemplary embodiment of the present invention; and

FIG. 8 illustrates a flowchart according to an exemplary method for MIMO detection according to exemplary embodiments of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

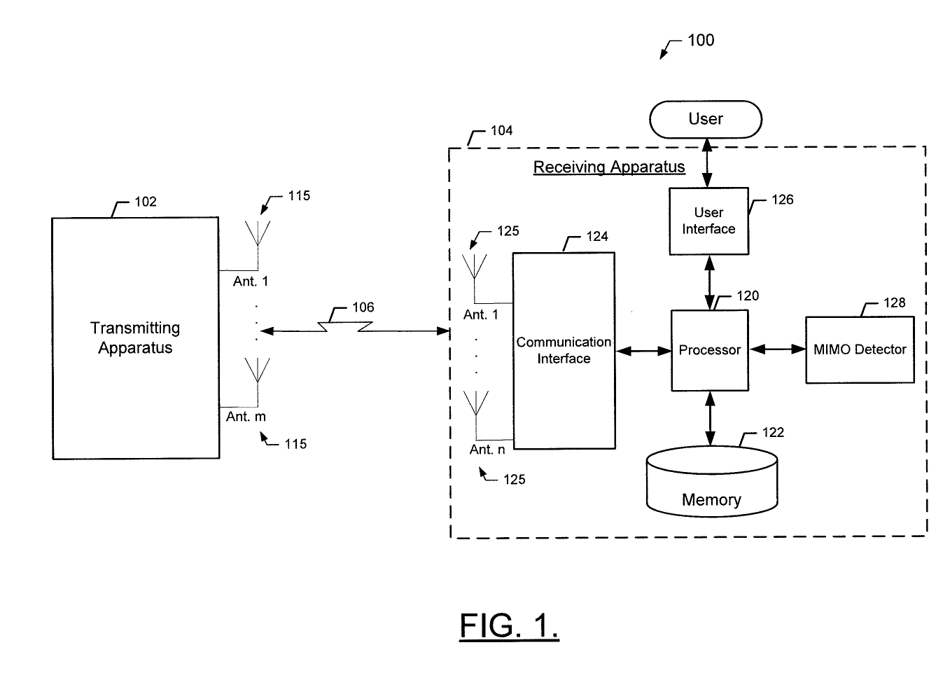

FIG. 1 illustrates a block diagram of a system 100 for MIMO detection according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for MIMO detection, numerous other configurations may also be used to implement embodiments of the present invention.

In at least some embodiments, the system 100 includes a transmitting apparatus 102 having a plurality of transmit antennas 115 and a receiving apparatus 104 having a plurality of receive antennas 125. The transmitting apparatus 102 is configured to transmit data and the receiving apparatus 104 is configured to receive data over the communications link 106. Although referred to as a “transmitting” apparatus and “receiving apparatus,” it will be appreciated that the terms are merely for purposes of illustrating a data transmission flow for MIMO detection at the receiving apparatus 104 according to exemplary embodiments of the invention and in various embodiments, the transmitting apparatus 102 may be further configured to receive data and/or the receiving apparatus 104 may be further configured to transmit data.

The communication link 106 may comprise a wireless uplink and/or a downlink. In this regard, the transmitting apparatus 102 may be configured to transmit data to the receiving apparatus 104 via the communication link 106 in accordance with any wireless communications standard providing for MIMO communication. For example, such wireless communications standard may comprise IEEE 802.11n, IEEE 802.16e, WiMax, LTE, LTE-Advanced, International Mobile Telecommunications (IMT) Advanced, and/or the like.

The transmitting apparatus 102 may be embodied as a desktop computer, laptop computer, mobile terminal, mobile computer, mobile phone, mobile communication device, game device, digital camera/camcorder, audio/video player, television device, radio receiver, digital video recorder, positioning device, base station, router, network access point, any combination thereof, and/or the like having a plurality of antennas 115 that is configured to transmit data using the plurality of antennas 115 to the receiving apparatus 104 over the communications link 106.

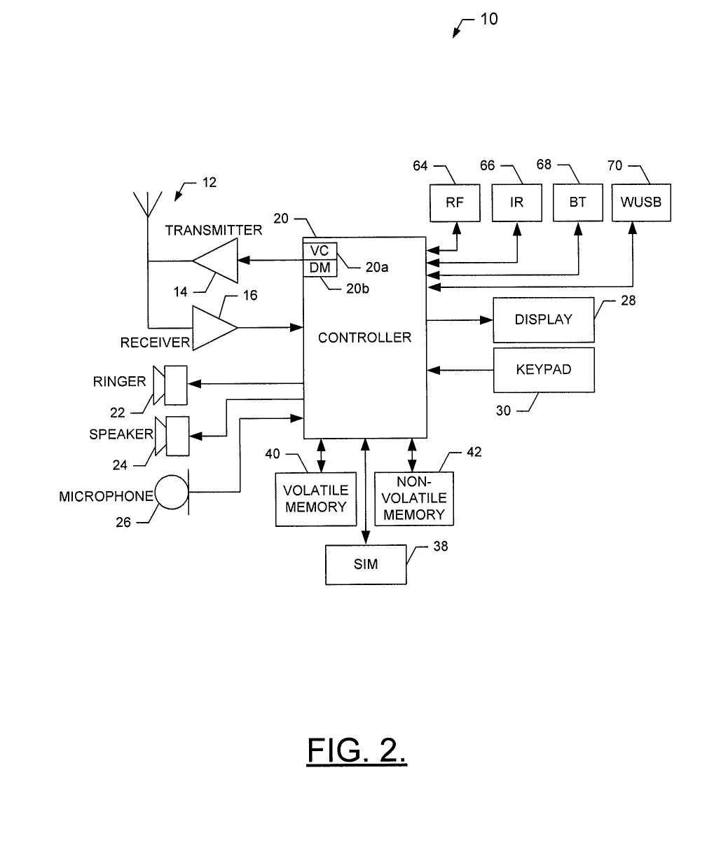

The receiving apparatus 104 may be embodied as a desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like that is configured to receive data transmitted by the transmitting apparatus 102 over the communications link 106. In an exemplary embodiment, the receiving apparatus 104 is embodied as a mobile terminal, such as that illustrated in FIG. 2.

In this regard, FIG. 2 illustrates a block diagram of a mobile terminal 10 representative of one embodiment of a receiving apparatus 104 in accordance with embodiments of the present invention. It should be understood, however, that the mobile terminal 10 illustrated and hereinafter described is merely illustrative of one type of receiving apparatus 104 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an exemplary embodiment, the receiving device 104 includes various means, such as a processor 120, memory 122, communication interface 124, user interface 126, and multiple-input, multiple-output (MIMO) detector 128 for performing the various functions herein described. These means of the receiving device 104 as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. The plurality of processors may be in operative communication with each other and may be collectively configured to perform one or more functionalities of the receiving device 104 as described herein. The plurality of processors may be embodied on a single computing device or distributed across a plurality of computing devices collectively configured to perform at least some of the functionality of the receiving apparatus 104 as described herein. In an exemplary embodiment, the processor 120 is configured to execute instructions stored in the memory 122 or otherwise accessible to the processor 120. These instructions, when executed by the processor 120, may cause the receiving apparatus 104 to perform one or more of the functionalities of the receiving apparatus 104 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may include, for example, volatile and/or non-volatile memory. Although illustrated in FIG. 1 as a single memory, the memory 122 may comprise a plurality of memories. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the receiving device 1104 to carry out various functions in accordance with exemplary embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the MIMO detector 128 during the course of performing its functionalities.

The communication interface 114 may be embodied as any device or means embodied in hardware, a computer program product comprising computer readable program instructions stored on a computer readable medium (e.g., the memory 122) and executed by a processing device (e.g., the processor 120), or a combination thereof that is configured to receive and/or transmit data from/to the transmitting apparatus 102 over the communication link 106. In an exemplary embodiment of the invention, the communication interface 124 comprises a plurality of antennas 125 for receiving data transmitted by the transmitting apparatus 102. In at least one embodiment, the communication interface 124 is at least partially embodied as or otherwise controlled by the processor 120. In this regard, the communication interface 124 may be in communication with the processor 120, such as via a bus. The communication interface 124 may further include, for example, a transmitter(s), a receiver(s), a transceiver(s) and/or supporting hardware or software for enabling communications with the transmitting apparatus 102 over the communication link 106. The communication interface 124 may be configured to receive and/or transmit data using any protocol or standard that may be used for communications between entities of the system 100. Accordingly, the communication interface 124 may be configured to receive and/or transmit data over a MIMO communications system. The communication interface 124 may additionally be in communication with the memory 122, user interface 126, and/or MIMO detector 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In some embodiments, such as where the receiving apparatus 104 is embodied as a server or network node, elements of the user interface 126 may be reduced or even eliminated. The user interface 126 may be in communication with the memory 122, communication interface 124, and/or MIMO detector 128, such as via a bus.

The MIMO detector 128 may be embodied as various means, such as hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In some embodiments wherein the MIMO detector 128 is embodied as hardware, the MIMO detector 128 may be at least partially embodied as one or more ASICs. In embodiments wherein the MIMO detector 128 is embodied separately from the processor 120, the MIMO detector 128 may be in communication with the processor 120. The MIMO detector 128 may further be in communication with the memory 122, communication interface 124, and/or user interface 126, such as via a bus. In some embodiments, the MIMO detector 128 comprises and/or is configured to implement one or more MIMO trellis structures according to embodiments of the invention, a log-likelihood ratio (LLR) generation unit, one or more QR decomposition units, and/or the like. It will be appreciated that QR decomposition is presented herein as an example of a matrix factorization used in some embodiments of the invention. The invention is not limited to QR decomposition and other embodiments of the invention apply other matrix factorization techniques, such as, for example, QL factorization. Thus, the MIMO detector 128 and/or QR decomposition units may be configured to apply one or more matrix factorization other techniques.

The antennas 125 may be configured to receive data, such as may comprise a symbol vector, transmitted over the communication link 106 by the transmitting apparatus 102. The communication interface 124 may then be configured to forward the received data to the MIMO detector 128 and/or store the received data in the memory 122. The MIMO detector 128 may be configured to receive data forwarded by the communication interface 124 and/or access data stored in the memory 122. The MIMO detector 128 may be further configured to consider a received symbol vector and generate a final list comprising a first predefined number of candidate transmit symbol vectors based at least in part upon the received symbol vector using a trellis. The trellis may comprise a plurality of nodes that apply a distributed list decoding to facilitate generation of the final list. The first predefined number of the most likely candidate transmit symbol vectors may comprise the first predefined number of the most likely candidate transmit symbol vectors derived from the set of all possible trellis paths based at least in part upon the respective cumulative trellis path weights. Thus, for example, depending on how edges between nodes of the trellis are weighted, the most likely candidate transmit symbol vectors may comprise the first predefined number of transmit symbol vectors derived from the first predefined number of trellis paths having the lowest cumulative trellis path weights. Alternatively, for example, such as if the trellis paths are assigned weights inverse to those assigned according to examples described herein, the most likely candidate transmit symbol vectors may comprise the first predefined number of transmit symbol vectors derived from the first predefined number of trellis paths having the highest cumulative trellis path weights.

MIMO detection according to various embodiments of the invention will now be described in more detail in the context of the system 100. It will be appreciated that the following discussion is for purposes of example and in no means is intended to be limiting on the scope of the invention. Thus, for example, where a 4×4 quadrature phase-shift keying (QPSK) MIMO communications system is described, it will be appreciated that embodiments of the invention may be used for MIMO detection in other types of MIMO communications systems. These other types may, for example, have a different number of transmit antennas, a different number of symbols in the constellation alphabet, and/or use other types of modulation, such as, for example, quadrature amplitude modulation (QAM).

A coded MIMO communication system according to embodiments of the invention may comprise M transmit antennas and N receive antennas. The MIMO transmission transmitted by the transmitting apparatus 102 may be modeled as:

y=Hs+n,

where H is an N×M complex matrix, s=[s₀, . . . , s_{M-1}]^{T} is an M×1 transmit vector, y is an N×1 received vector, and n is an independent identically distributed complex zero-mean Gaussian noise vector with variance σ² per direction. The symbol vector s may be obtained using the mapping function sₘ=map(x^{<m>}), m=0, . . . ,M−1, where x^{<m>} is an Mc×1 vector (block) of transmit data bits (x^{<m>}=[x₀, x₁, . . . , x_{Mc-1}]^{T}), and Mc is the number of bits per constellation symbol. For instance, Mc=2, s E {1+j, 1−j, −1+j, −1−j} in the case of QPSK, and Mc=4, s E {±1 ±j, ±1 ±3j, ±3 ±j, ±3 ±3j} in the case of 16-QAM.

The concatenating x^{<0>}, . . . , x^{<M-1>} is written in x. The MIMO detector 128 may be configured to compute the soft information for bit xₖ, for k=0, . . . , M·Mc−1. The soft information may be expressed as a LLR value (L-value):

$$L ( {x}_{k} \vert y ) = ln \frac{P [ {x}_{k} = + 1 \vert y ]}{P [ {x}_{k} = - 1 \vert y ]} = {L}_{A} ( {x}_{k} ) + {L}_{E} ( {x}_{k} ) ,$$

where LA and LE denote the a priori L-value and extrinsic L-value, respectively. Assuming there is no prior knowledge of the transmit signal, using the max-log approximation, the LLR may be simplified to:

$$L ( {x}_{k} \vert y ) \approx \frac{1}{2 {σ}^{2}} ( {min}_{x ∈ {X}_{k , - 1}} d ( s , y ) - {min}_{x ∈ {X}_{k , + 1}} d ( s , y ) ) ,$$

where set X_{k,+1}={x|xₖ=+1} and set X_{k,-1}={x|xₖ=−1}. Using QR decomposition according to H=QR, where Q and R refer to an N×M unitary matrix and an M×M upper triangular matrix, respectively, the Euclidean distance d(s, y) can be calculated as

d(s,y)=∥y−H·s∥²=∥ŷ−R·s∥²+C,

where ŷ=Q^{H}y, and C is a constant (C=0 if M=N.)

In embodiments of the invention, the MIMO detector 128 is configured to consider a received symbol vector and determine a first predefined number of transmit candidate symbol vectors having the smallest distances between the received symbol vector and the expected received symbol vector for each trellis node. In this regard, the MIMO detector 128 in embodiments of the invention is configured to generate a final list of the first predefined number of most likely candidate symbol vectors for each trellis node through soft detection. After QR decomposition in an example 4×4 QPSK system, the Euclidean distance may be written as:

d=γ₀+γ₁+γ₂+γ₃.

where

γ₀(s₃)=∥ŷ₃−R₃₃s₃∥²

γ₁(s₂₋₃)=∥ŷ₂−(R₂₂s₂+R₂₃s₃)∥²

γ₂(s₁₋₃)=∥ŷ₁−(R₁₁s₁+R₁₂s₂+R₁₃s₃)∥²

γ₃(s₀₋₃)=∥ŷ₀−(R₀₀s₀+R₀₁s₁+R₀₂s₂+R₀₃s₃)∥²

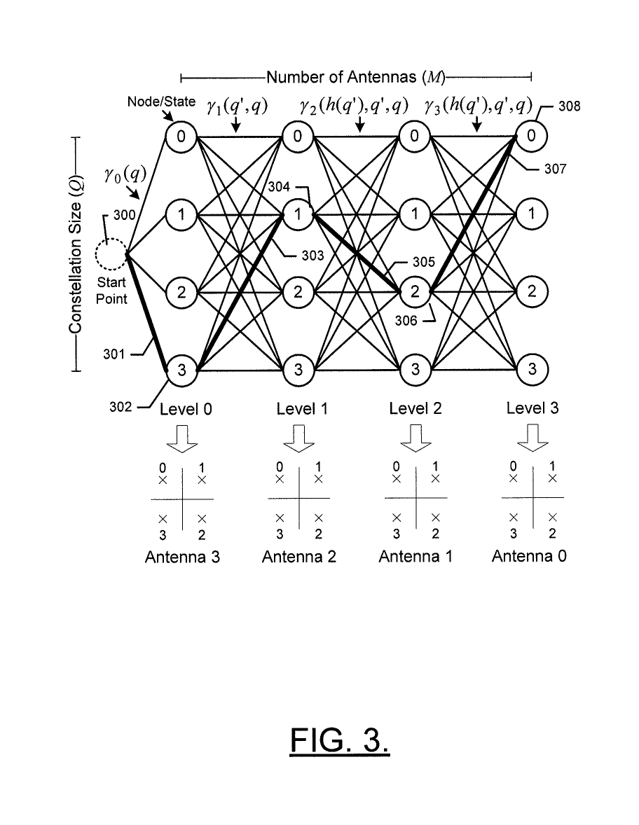

This process can be visualized according to embodiments of the invention using an example trellis diagram for MIMO detection according to an exemplary embodiment of the present invention, which is illustrated in FIG. 3. The MIMO detector 128 in embodiments of the invention may comprise and/or be configured to construct a MIMO trellis, such as that illustrated in FIG. 3. The nodes of the MIMO trellis according to embodiments of the invention are ordered into M levels (also referred to as “stages”), where M is the number of transmit antennas. For example levels 0, 1, 2, 3 may correspond to antennas 3, 2, 1, 0 respectively. Each level of the example trellis may comprise Q nodes, where Q is the constellation alphabet size. The Q nodes of a level may be linearly arranged (e.g., vertically arranged). Thus, each node may be mapped to a possible complex constellation point. The trellis may be fully connected so that there are Q^{M} number of different paths through the trellis. For example, a path between the start point 300, node 302 in level 0, node 304 in level 1, node 306 in level 2, and node 308 in level 3 may be represented by the edges 301, 303, 305, and 307 that connect the respective nodes. The nodes in level k may be represented as vₖ(q) (0<=q<=Q−1). The edge between nodes vₖ₋₁(q′) and vₖ(q) may have a weight represented by γₖ(h(q′),q′,q), where h(q′) denotes the nodes encountered before node vₖ₋₁(q′) along the path. Accordingly, the MIMO detector 128 may be configured to calculate the weight of an edge between two respective nodes of a trellis, such as that illustrated in FIG. 3. Because of the upper triangular property of R, the weight function dose not depend on the future levels, but rather depends on its current and previous levels.

Given a received, possibly noisy MIMO symbol transmitted by the transmitting apparatus 102, the MIMO detector 128 may be configured to associate each edge in the trellis with weight so that the problem of ML detection reduces to the problem of finding the minimum-weight path in the trellis. Then the nodes encountered along this path by the MIMO detector 128 may comprise the hard detected transmit symbol vector. Accordingly, each transmit symbol vector may comprise a path through the trellis diagram such that each symbol in the transmit symbol vector corresponds to a symbol to which a respective node traversed along the path is mapped. The MIMO detector 128 may be configured to measure the likelihood of a potential candidate by the Euclidean distance between the received vector and the expected received vector. The MIMO detector 128 may be configured to implement a D-LIST algorithm in accordance with embodiments of the invention to select a list of symbol vectors which are the most likely candidates according to the given criterion. Thus, the list for each trellis node may comprise the L most likely candidates having the L lowest cumulative trellis path weights among the set of all possible trellis path weights. Alternatively, such as if the trellis edges are weighted inversely as described for example herein, the list for a trellis node may comprise the L most likely candidates having the L highest cumulative trellis path weights among the set of all possible trellis path weights. Each trellis stage has Q nodes. Each node has a list of L most likely candidates. Thus, these QL candidates form a list of most likely candidates for this trellis stage. Accordingly, L may comprise any integer value defining how many candidate trellis paths are determined by a node of the MIMO detector 128 depending on the configuration of the MIMO detector 128. In some embodiments of the invention, the value of L is greater than 1. In the example trellis diagram of FIG. 3, each branch has a weight γ and the MIMO detector 128 may be configured to calculate full-path distance by summing the branch weights along the path. In this regard, the MIMO detector 128 may be configured to add the branch metric γ each time to the partial Euclidean distance:

dₖ(q)=dₖ₋₁(q′)+γₖ(h(q′), q′, q),

where q′ and q denote the node number at level k−1 and k respectively. The branch metric may be dependent on the nodes (each node may be associated with a complex values sⱼ) encountered along the path:

$${γ}_{k} ( h ( {q}^{′} ) , {q}^{′} , q ) = {‖ {{y}^{⋒}}_{M - 1 - k} - {\sum }_{j = M - 1 - k}^{M - 1} {R}_{( M - 1 - k , j )} {s}_{j} ‖}^{2}$$

To generate the soft LLR information, the MIMO detector 128 may be configured to navigate through the trellis and find a list of most likely L paths for each node—the paths with L smallest cumulative weights. The MIMO detector 128 may be further configured to distribute the search operation among all the vertical nodes at each trellis level and keep a list of L (L>1) best candidates at each node. The implementation of this distributed list (D-LIST) search algorithm by the MIMO detector 128 may provide benefits including, for example, (1) the sorting cost are significantly reduced compared to the centralized search solution, and (2) the bit error rate (BER) performance is improved because each possible node may equally have a list of L candidates which may eliminate LLR clipping issues.

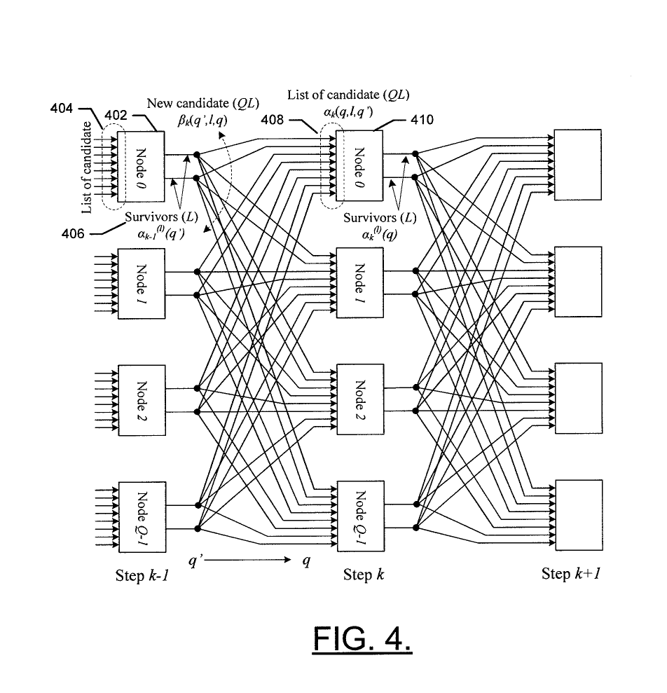

Referring now to FIG. 4, FIG. 4 illustrates a flow diagram of a distributed list trellis decoding algorithm according to an exemplary embodiment of the present invention. In this regard, a node 402 may receive a list of candidate paths 404. The MIMO detector 128 may be configured to determine at the node 402 located in the level represented by “step k−1” of the list of candidates 404 the L most likely candidate paths to the node 402. In the example of FIG. 4, L is equal to two. These determined survivors 406 may then be forwarded by the MIMO detector 128 to each node in the subsequent level, represented by “step k.” Thus, for example, node 410 in the level represented by “step k” may receive from each of the nodes in the level represented by “step k−1”L candidate paths determined by each respective node for a total of QL candidate paths, as there are Q nodes in the level represented by “step k−1.” Based at least in part upon those received QL candidate paths, the MIMO detector 128 may be configured to determine for the node 410 the L most likely candidate paths to node 410. The MIMO detector 128 may then forward those L candidate paths to the Q nodes in the level represented by “step k+1.”

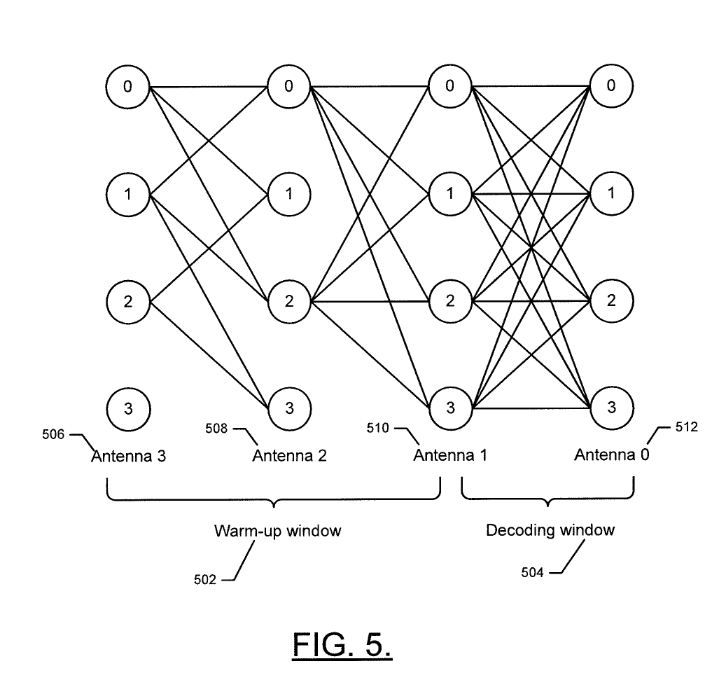

When the transmitting apparatus 102 has more than two antennas 115, the MIMO detector 128 may be configured to implement a windowed D-LIST algorithm for soft MIMO detection. In this regard, the MIMO detector 128 may comprise and/or be configured to construct a trellis divided into two windows: warm-up window 502 and decoding window 504 as shown in FIG. 5. The length of the decoding window (e.g., the number of levels in the decoding window, also referred to as the “third predefined number”) is 2, which means the MIMO detector 128 may only fully detect Antenna 1 510 and Antenna 0 512, which reside in the decoding window 504. For a simple example, the list size L is assumed to be 2 in FIG. 5. In this regard, for a MIMO system having M transmit antennas (e.g., wherein the transmitting apparatus 102 comprises M transmit antennas 115), in embodiments of the invention, the warm-up window may comprise the first M−2 levels of the trellis and the decoding window may comprise the final 2 levels of the trellis. However, it will be appreciated that this configuration is provided for purposes of example and in accordance with other embodiments of the invention, the warm-up window may be abstracted to comprise the first M-x levels of the trellis, wherein x is a predefined number having an integer value less than M, and the decoding window may comprise the final x levels of the trellis.

In FIG. 5, only the survivor edges for the L most likely paths to each respective node are kept by respective nodes in the levels of the warm-up window 502 and shown in the warm-up window 502, whereas all the edges are shown in the decoding window 504. In the warm-up window 502, the MIMO detector 128 may be configured to prune the unlikely paths by applying a D-LIST algorithm. In the decoding window 504, the MIMO detector 128 may be configured to examine every possible path to find the minimum Euclidean distance for each node contained in the levels (e.g., levels 510 and 512) of the decoding window 504.

The MIMO detector 128 may be configured to implement the following windowed D-LIST algorithm in embodiments of the invention:
0. Initialization: Set level k=0; Set path metric αₖ(q)=γₖ(q) for q=0,1, . . . ,Q−1; Retain the only path coming from the start point for each node v₀(q).
1. Path Extension: k=k+1. For each node vₖ₋₁(q′), the retained L best paths are fully extended for the next level. The newly extended path metric β is updated as:

βₖ(q′,l,q)=α^{(l)}ₖ₋₁(q′)+γₖ(h(q′),q′,q)

where α^{(l)}ₖ₋₁(q′) are the L survivors of node vₖ₋₁(q′) (in the ascending order, l=0,1, . . . ,L−1).
2. Path Selection: Due to the trellis structure, the newly extended candidates β need to be permuted to create candidates α for the next level of the trellis as: αₖ(q,l,q′)=βₖ(q′,l,q). Then, from each candidate list for node vₖ(q), the best L paths are selected from αₖ(q,l,q′) as the survivors:

α⁽⁰⁾ₖ(q)<α⁽¹⁾ₖ(q)< . . . <α^{(L-1)}ₖ(q)
3. List Creation:

if (K<M−1) go back to step 1.

else

Create Two Lists:

List 1={α^{l}_{M-1}(q)}, for q=0,1, . . . ,Q−1,l=0,1, . . . ,L−1

List 2={β^{l}_{M-1}(q′)}, for q′=0,1, . . . ,Q−1,l=0,1, . . . ,L−1

where β^{l}_{M-1}(q′) is the L best outgoing paths out of the fully extended paths β_{M-1}(q′,l,q):

β⁽⁰⁾_{M-1}(q)<β⁽¹⁾_{M-1}(q)< . . . <β^{(L-1)}_{M-1}(q)

end if
4. Output: Combine two lists and output them

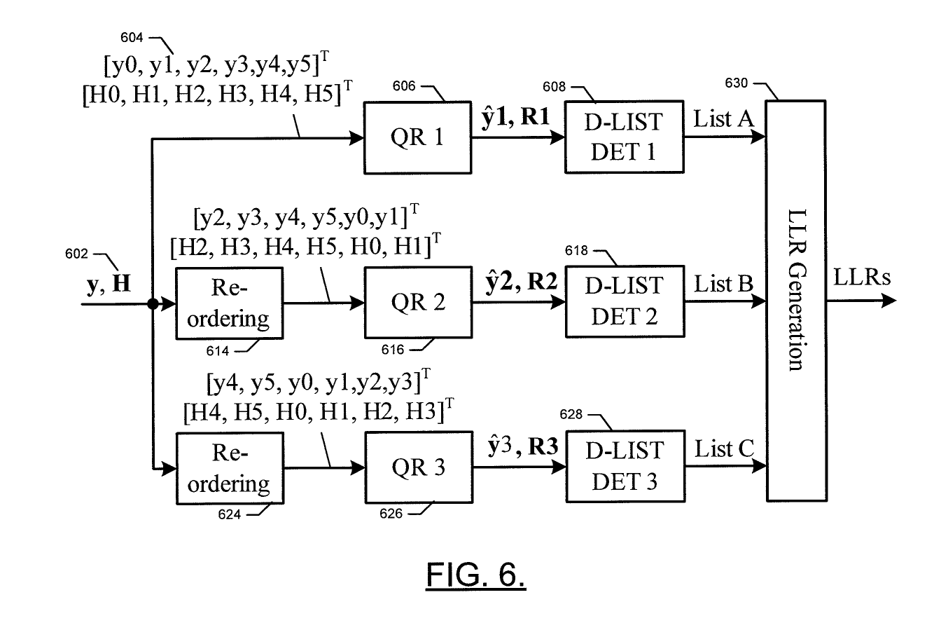

Since for the windowed D-LIST algorithm, only the antennas (e.g. levels) inside the decoding window may be fully decoded by the MIMO detector 128, the MIMO detector 128 may comprise and/or be configured to construct multiple trellises by re-ordering, or permuting, the antenna (e.g., level) ordering such that every antenna may be fully decoded to generate accurate LLRs for symbols transmitted by every transmit antenna 115. In this regard, the multiple trellises may be constructed by re-ordering the received vector and channel matrices. FIG. 6 illustrates a block diagram of a multi-trellis distributed list decoding algorithm implemented by the MIMO detector 128 according to an exemplary embodiment of the present invention. In this regard, FIG. 6 illustrates elements that may comprise the MIMO detector 128 and/or functionalities that the MIMO detector 128 may be configured to perform. FIG. 6 illustrates a block diagram of a multi-trellis distributed list decoding algorithm implemented by the MIMO detector 128 for an M=6 transmit antenna system and wherein the number of antennas (e.g., levels) in the decoding window is 2. In FIG. 6, three trellises comprise or are created by the MIMO detector 128 by re-ordering (or permuting) the received vector y and channel matrix H at re-ordering units 614 and 624 and feeding the resulting vectors and matrices into QR decomposition units 606, 616, and 626. The MIMO detector 128 then feeds the results of QR decomposition units 606, 616, and 626 into D-LIST detector units 608, 618, and 628, respectively, wherein the MIMO detector 128 may generate three lists of most likely candidate symbol vectors. The MIMO detector 128 may then combine the three generated lists, List_A, List_B and List_C, into the final candidate list. The MIMO detector 128 may then be configured to calculate the LLR of each transmit bit at the LLR generation block 630 as:

$$L ( {x}_{k} \vert y ) = \frac{1}{2 {σ}^{2}} ( {min}_{x ∈ {ℒ}_{k , - 1}} d - {min}_{x ∈ {ℒ}_{k , + 1}} d )$$

Accordingly, the LLR clipping issue (due to the non-existing terms in the max-log calculation) may be avoided by ensuring that both d(xₖ=1) and d(xₖ=−1) will exist in the final candidate lists. More generally, for an M antenna system, wherein the decoding window comprises x antennas, or levels, the MIMO detector 128 may comprise and/or be configured to construct ┌M/x┐ different trellises for the LLR generations. Thus, for example, when the decoding window comprises 2 antennas, or levels, the MIMO detector 128 may comprise and/or be configured to construct ┌M/2┐ different trellises for the LLR generations.

Once the MIMO detector 128 has completed generating the soft decoding information through completion of LLR generations, the MIMO detector 128 may be configured to store the soft decoding information (e.g., LLR generations) in the memory 122 and/or forward the soft decoding information to an outer error correction code decoder. Thus, although not illustrated in FIG. 1, the receiving apparatus 104 may further comprise an outer error correction code decoder that may be configured to receive soft decoding information from the MIMO detector 128 and/or access soft decoding information stored in the memory 122. The outer error correction code decoder may, for example, comprise a Turbo decoder, Viterbi decoder, low density parity check (LDPC) decoder, and/or the like. The outer error correction code decoder may be configured to use the generated LLR values and/or other soft decoding information to reconstruct the data sent by the transmitting device 102.

The predefined number defining the total number of candidate transmit symbol vectors detected by the MIMO detector 128 (also referred to as the “first predefined number”) and included in the generated list of candidate transmit symbol vectors may be determined based at least in part upon the size of the constellation alphabet (Q) and the distributed list size (L, also referred to as the “second predefined number”). Thus, for example, for a given trellis having Q nodes in the last stage, each of which determines the L most likely paths to the node, the MIMO detector 128 may be configured to detect QL candidate transmit symbol vectors to be included in the final list of candidate transmit symbol vectors. In embodiments wherein the trellis is divided into a warm-up window and a decoding window, the predefined number may be determined further based at least in part upon the number of levels in the decoding window (x, also referred to as the “third predefined number”). Thus, the MIMO detector 128 for a given trellis may be configured to detect QLx transmit symbol vectors to be included in the final list of candidate transmit symbol vectors. In embodiments wherein multiple trellises are generated through permutation so that each transmit antenna is fully decoded, the predefined number may be determined further based at least in part upon the number of trellises (y), such that the MIMO detector 128 for a given received symbol vector may be configured to detect up to QLxy candidate transmit symbol vectors to be included in the final list of candidate transmit symbol vectors.

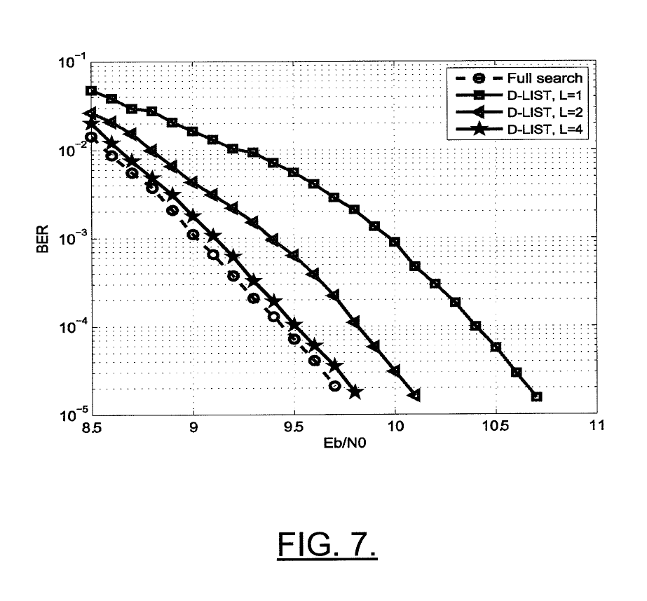

FIG. 7 illustrates a graph showing a bit error rate performance comparison according to an exemplary embodiment of the present invention. In this regard, FIG. 7 illustrates simulation results according to an embodiment of the invention using different distributed list size's L.

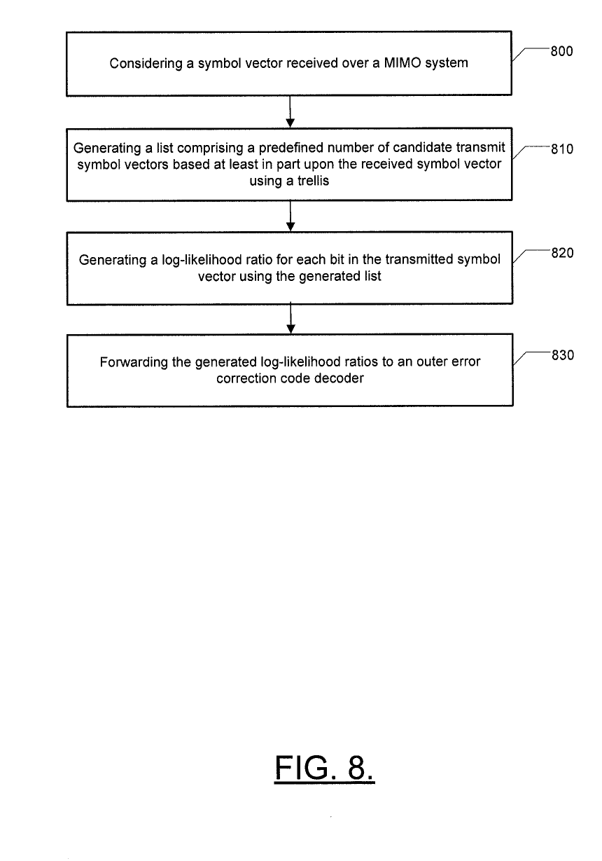

FIG. 8 illustrates a flowchart according to an exemplary method for MIMO detection according to exemplary embodiments of the invention. The method may include the MIMO detector 128 considering a symbol vector received over a MIMO system, at operation 800. Operation 810 may comprise the MIMO detector 128 generating a list comprising a predefined number of candidate transmit symbol vectors based at least in part upon the received symbol vector using a trellis. The trellis may comprise a plurality of nodes configured to apply distributed list decoding to generate the list. The list of the predefined number of candidate transmit symbol vectors may comprise the predefined number of candidate transmit symbol vectors derived from the set of all possible trellis paths as determined based at least in part upon the respective cumulative trellis path weights. Operation 820 may comprise the MIMO detector 128 generating a log-likelihood ratio for each bit in the transmitted symbol vector using the generated list. The MIMO detector 128 may then forward the generated log-likelihood ratios to an outer error correction code decoder, at operation 830.

FIG. 8 is a flowchart of a system, method, and computer program product according to exemplary embodiments of the invention. It will be understood that each block or step of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices and network operators. Embodiments of the invention provide methods, apparatuses, and computer products implementing a distributed list, trellis decoding algorithm having a scalable list size (L) offering greater search efficiencies than prior MIMO detection algorithms. In this regard, embodiments of the invention provide for soft detection for each bit in the transmitted vector that may then be forwarded to an outer channel decoder. Some embodiments of the invention use multiple MIMO trellises to generate more accurate log-likelihood ratios for candidate symbol vectors for forwarding to an outer channel decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
considering, at a multiple-input, multiple-output detector, a symbol vector received over a multiple-input, multiple-output system; and
generating a list comprising a first predefined number of candidate transmit symbol vectors based at least in part upon the received symbol vector using a trellis comprising a plurality of nodes that apply distributed list decoding to generate the list, wherein the list of the first predefined number of candidate transmit symbol vectors comprises the first predefined number of candidate transmit symbol vectors derived from the set of all possible trellis paths as determined based at least in part upon the respective cumulative trellis path weights.

2. The method of claim 1, wherein the plurality of nodes of the trellis are arranged into a number of levels equal to a number of transmit antennas in the multiple-input, multiple-output system, wherein each level comprises a number of nodes equal to a size of a constellation alphabet, and wherein each node maps to a single symbol in the constellation alphabet.

3. The method of claim 2, wherein each candidate transmit symbol vector comprises a vector of symbols corresponding to symbols mapped to respective nodes traversed along the trellis path from which the candidate transmit symbol vector is derived.

4. The method of claim 2, wherein a node applies list decoding by pruning potential candidate paths to the node to a second predefined number of most likely candidate paths to the node and when the trellis comprises a level subsequent to the level in which the node is located forwarding the second predefined number of most likely candidate paths to each node in the subsequent level such that sorting candidate paths is distributed among the plurality of nodes of the trellis, wherein the second predefined number is equal to a predefined distributed list size, and wherein the first predefined number is defined based at least in part upon the second predefined number and the size of the constellation alphabet.

5. The method of claim 4, wherein the trellis is divided into a warm-up window comprising all but a third predefined number of last levels of the trellis and a decoding window comprising the last third predefined number of levels of the trellis, wherein for nodes of the trellis in the warm-up window paths not among the second predefined number of most likely candidate paths to the nodes of the trellis in the warm-up window are pruned, and wherein for nodes of the trellis in the decoding window every possible path is examined to detect a minimum Euclidian distance for a trellis path to each node in the decoding window, and wherein the first predefined number is further defined based at least in part upon the third predefined number.

6. The method of claim 5, wherein generating the list using a trellis comprises generating the list using a plurality of trellises, the plurality of trellises comprising a number of trellises equal to a ceiling of the number of transmit antennas divided by the third predefined number, wherein ordering of levels in the trellises is permuted such that each of the transmit antennas is fully decoded in at least one of the trellises to generate log-likelihood ratios for symbols transmitted by each of the transmit antennas, and wherein the first predefined number is further defined based at least in part upon the number of trellises.

7. The method of claim 1, further comprising:
generating a log-likelihood ratio for each bit in the transmit symbol vector using the generated list; and
forwarding the generated log-likelihood ratios to an outer error correction code decoder.

8. A computer program product comprising at least one computer-readable storage medium having computer-readable program instructions stored therein, the computer-readable program instructions comprising:
a program instruction for considering a symbol vector received over a multiple-input, multiple-output system; and
a program instruction for generating a list comprising a first predefined number of candidate transmit symbol vectors based at least in part upon the received symbol vector using a trellis comprising a plurality of nodes that apply distributed list decoding to generate the list, wherein the list of the first predefined number of candidate transmit symbol vectors comprises the first predefined number of candidate transmit symbol vectors derived from the set of all possible trellis paths as determined based at least in part upon the respective cumulative trellis path weights.

9. The computer program product of claim 8, wherein the plurality of nodes of the trellis are arranged into a number of levels equal to a number of transmit antennas in the multiple-input, multiple-output system, wherein each level comprises a number of nodes equal to a size of a constellation alphabet, and wherein each node maps to a single symbol in the constellation alphabet.

10. The computer program product of claim 9, wherein each candidate transmit symbol vector comprises a vector of symbols corresponding to symbols mapped to respective nodes traversed along the trellis path from which the candidate transmit symbol vector is derived.

11. The computer program product of claim 9, wherein the program instruction for generating the list comprises instructions causing a node to apply list decoding by pruning potential candidate paths to the node to a second predefined number of most likely candidate paths to the node and when the trellis comprises a level subsequent to the level in which the node is located to forward the second predefined number of most likely candidate paths to each node in the subsequent level such that sorting candidate paths is distributed among the plurality of nodes of the trellis, wherein the second predefined number is equal to a predefined distributed list size, and wherein the first predefined number is defined based at least in part upon the second predefined number and the size of the constellation alphabet.

12. The computer program product of claim 11, wherein the trellis is divided into a warm-up window comprising all but a third predefined number of last levels of the trellis and a decoding window comprising the last third predefined number of levels of the trellis, wherein the program instruction for generating the list comprises instructions for pruning paths not among the second predefined number of most likely candidate paths to nodes of the trellis in the warm-up window, and wherein the program instruction for generating the list comprises instructions for examining every possible path to detect a minimum Euclidian distance for a trellis path to each node of the trellis in the decoding window, and wherein the first predefined number is further defined based at least in part upon the third predefined number.

13. The computer program product of claim 12, wherein the program instruction for generating the list using a trellis comprises instructions for generating the list using a plurality of trellises, the plurality of trellises comprising a number of trellises equal to a ceiling of the number of transmit antennas divided by the third predefined number, wherein ordering of levels in the trellises is permuted such that each of the transmit antennas is fully decoded in at least one of the trellises to generate log-likelihood ratios for symbols transmitted by each of the transmit antennas, and wherein the first predefined number is further defined based at least in part upon the number of trellises.

14. An apparatus comprising at least one processor and at least one memory storing computer program code, wherein the at least one memory and stored computer program code are configured to with the at least one processor cause the apparatus to at least:
consider a symbol vector received over a multiple-input, multiple-output system; and
generate a list comprising a first predefined number of candidate transmit symbol vectors based at least in part upon the received symbol vector using a trellis comprising a plurality of nodes that apply distributed list decoding to generate the list, wherein the list of the first predefined number of candidate transmit symbol vectors comprises the first predefined number of candidate transmit symbol vectors derived from the set of all possible trellis paths as determined based at least in part upon the respective cumulative trellis path weights.

15. The apparatus of claim 14, wherein the plurality of nodes of the trellis are arranged into a number of levels equal to a number of transmit antennas in the multiple-input, multiple-output system, wherein each level comprises a number of nodes equal to a size of a constellation alphabet, and wherein each node maps to a single symbol in the constellation alphabet.

16. The apparatus of claim 15, wherein each candidate transmit symbol vector comprises a vector of symbols corresponding to symbols mapped to respective nodes traversed along the trellis path from which the candidate transmit symbol vector is derived.

17. The apparatus of claim 15, wherein the at least one memory and stored computer program code are configured to with the at least one processor to further cause the apparatus to cause a node to apply list decoding by pruning potential candidate paths to the node to a second predefined number of most likely candidate paths to the node and when the trellis comprises a level subsequent to the level in which the node is located forwarding the second predefined number of most likely candidate paths to each node in the subsequent level such that sorting candidate paths is distributed among the plurality of nodes of the trellis, wherein the second predefined number is equal to a predefined distributed list size, and wherein the first predefined number is defined based at least in part upon the second predefined number and the size of the constellation alphabet.

18. The apparatus of claim 17, The computer program product of claim 11, wherein the trellis is divided into a warm-up window comprising all but a third predefined number of last levels of the trellis and a decoding window comprising the last third predefined number of levels of the trellis, wherein the at least one memory and stored computer program code are configured to with the at least one processor to cause the apparatus to generate the list by pruning paths not among the second predefined number of most likely candidate paths to nodes of the trellis in the warm-up window, and to examine every possible path to detect a minimum Euclidian distance for a trellis path to each node of the trellis in the decoding window, wherein the first predefined number is further defined based at least in part upon the third predefined number.

19. The apparatus of claim 18, wherein the at least one memory and stored computer program code are configured to with the processor cause the apparatus to generate the list using a trellis by generating the list using a plurality of trellises, the plurality of trellises comprising a number of trellises equal to a ceiling of the number of transmit antennas divided by the third predefined number, wherein ordering of levels in the trellises is permuted such that each of the transmit antennas is fully decoded in at least one of the trellises to generate log-likelihood ratios for symbols transmitted by each of the transmit antennas, and wherein the first predefined number is further defined based at least in part upon the number of trellises.

20. The apparatus of claim 14, wherein the apparatus comprises or is embodied on a mobile terminal.
